(19) United States
(12) Patent Application Publication
(10) Pub. No.: US 2026/0364696 A1
(43) Pub. Date: Nov. 19, 2026

(54) IMPROVEMENTS TO POLISHING AND/OR MACHINING APPARATUS AND METHOD USING ELECTROCHEMICAL MACHINING OR ELECTRIC DISCHARGE MACHINING

(71) Applicant: Holdson Limited, Huddersfield, Yorkshire (GB)

(72) Inventors: Philip Neil Dickinson, Huddersfield, Yorkshire (GB); Aaron Matthew Holt, Huddersfield, Yorkshire (GB); Philip Sean Wainwright, Huddersfield, Yorkshire (GB)

(21) Appl. No.: 19/148,218

(22) PCT Filed: Jan. 17, 2024
(86) PCT No.: PCT/GB2024/050124

§ 371 Date: Jul. 15, 2025

(30) Foreign Application Priority Data
Jan. 17, 2023 (GB) 2300675.2

(51) Int. Cl. B23H 7/22; B23H 7/26

(52) U.S. Cl. CPC B23H 7/22; B23H 7/26

(57) ABSTRACT

The invention relates to apparatus and a method for use in creating a machining or polishing effect on a surface of an article located with respect to the apparatus. The apparatus includes at least one electrode assembly including a base or plate and at least one deformable portion which is relatively moveable in response to contact being made with a surface of the article to substantially take the shape profile impression of the surface of the article, allowing closer and contact across the surface with the electrode assembly and hence allowing improved granularity and quality of polishing or machining of the surface.

The invention to which this application relates is to the provision of apparatus and a method for use to provide a polishing or machining operation on an article and particularly, although not necessarily exclusively, to apparatus for conductive Electro Chemical Machining (ECM) or non-conductive Electrical Discharge Machining (EDM) operation, to improve and/or adapt the surface quality of an item. The apparatus can be more generally referred to as non-conventional machining apparatus using an electrical supply thereto in order to remove material from an electrically conductive article.

The use of this form of apparatus and method is relatively well known and the same operates without direct contact between the article and an electrode of the apparatus

In the EDM process a relatively high voltage and lower current is used and once the dielectric properties of a dielectric fluid in which the article is positioned are achieved, a spark causes an amount of material from the article to be removed. In the ECM process a relatively lower voltage and a higher current is used and a chemical bond between the dielectric fluid and an amount of material of the article is created and the bonded material is removed from the article and typically forms a hydroxide of the article material which is held in suspension in the fluid and is removed by a filtration system. In both types of the apparatus it is conventionally required that the electrode has the same or an inverse near-net shape of the entire article, if the outer surface of the same is to be polished, or, if the surface of the article is to be machined, the electrode is required to have a positive or negative shape of the profile of the part of the article which is be machined, depending on whether the profile is to be effectively embossed below the surrounding surface, or to be extruded above the surrounding surface of the article.

A problem with these forms of apparatus and method of use of the same is that it can be difficult to achieve an accurate uniform surface finish over the entire surface of the article and in particular, when the article is formed with a relatively complex surface shape. For example, it is found that portions of the surface which are furthest removed from a stream of the dielectric fluid, often have an inferior surface finish in comparison with portions of the article surface which are directly in the stream of the dielectric fluid. This problem is further exacerbated when one considers that typically the shape of the articles which are to be polished or machined, differ from article to article and so the quality of surface finish which can be achieved using the same apparatus may vary from article to article and with regard to the particular shape of surface.

Thus, with both forms of the non-conventional machining processes, and in polishing or machining processes, the creation of the electrode to have the required shape is both time consuming, expensive and still prone to causing problems with regard to the quality of the end finish.

While the problem of cost and time can be a smaller issue when relatively large volumes of articles are to be processed using the same electrode components, this is not possible for relatively short production runs, or for use with respect to a “one-off” article. This, in turn can reduce the use of this form of apparatus and method.

An aim of the present invention is therefore to provide an electrode, and a method for determining the shape of the same, which allows the shape of the electrode which is created to be a Near Net shape electrode with sufficiently accurate dimensions so as to allow the required quality of the polishing or machining of the article to be achieved.

A further aim is to allow the electrode to be created in a cost-effective manner and to provide a level of adaptability in terms of the possibility to change and adapt the shape of the electrode to allow for repeated use of the electrode with different articles and/or surface shapes.

In a first aspect of the invention, there is provided apparatus for use in creating a machining or polishing effect on a surface of an article located with respect to said apparatus, said apparatus including at least one electrode assembly including a base or plate and at least one deformable portion which is relatively moveable in response to contact with a surface of the said article so as to substantially take the shape profile impression of said article surface.

In one embodiment the apparatus is a non-conventional machining and/or polishing apparatus such as Electrochemical machining (ECM) or Electrical Discharge Machining (EDM) apparatus.

In one embodiment the said deformable portion is formed by a group of members, each having a free end such that, as a group and in combination, the free ends of said members take the shape profile impression of said surface with which the same contact.

In one embodiment the shape profile impression is created by the relative axial offset of the free ends of the members in the group of members.

In one embodiment electrode assembly includes means to retain the said members in their respective positions and hence maintain the shape profile impression created by the free ends of the respective members.

Typically, each of the said members in the group is independently movable within a predefined range of movement with respect to a plate provided as part of the electrode assembly. Typically, the said members are restricted to linear movement along their respective longitudinal axes.

Typically, the said electrode assembly deformable portions are provided to be conductive so as to allow the apparatus to be operable via said members to create the required surface finish on the surface of the article adjacent to the free end of said members.

In one embodiment, the holder may also be conductive.

In one embodiment the apparatus includes biasing means to bias the free ends of the said members towards contact with eth surface of said article.

Typically, the said members are located with respect to a conductive membrane which has a conductive surface with a degree of flexibility which is sufficient to allow the members to be movable with respect thereto along their longitudinal axes without sticking to the membrane and hence allow the members to be movable under the influence of biasing means to contact with and take the form of the said article.

Typically the elasticity of the membrane is selected in order to limit the deviation between adjacent members to be within a tolerance range which is acceptable for the specific use with respect to a specific article.

In one embodiment the electrode assembly includes a plurality of deformable portions formed by groups of said members.

In one embodiment a plurality of the electrode assemblies are provided and, in one embodiment a first electrode assembly is located to one side of the said article and a second electrode assembly is provided on a second opposing side of the said article. Typically, movement means are provided to move said first and second electrode assemblies towards each other and into contact with said article.

In one embodiment the said electrode assemblies are provided to form, or form part of, the wall of a bath or container in which said article is located and, in one embodiment in which dielectric fluid is located.

In one embodiment the apparatus includes a range of membranes and/or members with differing configurations and/or characteristics and the operator of the apparatus may select which of the said membrane and/or member configuration to be located with the apparatus in dependence upon the work which is required to be performed, the quality of finish which is required to be achieved and/or the type and shape of article.

In an alternative embodiment, the assembly includes a deformable portion in the form of a flexible outer skin and which defines therein a cavity in which a fluid material is held, and the said article surface is positioned against the flexible outer skin to allow the same to change shape into the profile shape of the surface of the article.

Typically, a first electrode assembly is provided on a first side of the article and a second electrode assembly is provided on a second, typically opposing, side of the said article and the position of one or more of said assemblies and/or article with respect to each other is adjustable so as to allow relative movement and contact of the same and hence cause the specific shape profile impression of the article to be impressed into the deformable portions of the electrode assembly. In other embodiments further electrode assemblies may be provided.

In one embodiment this process is performed to in order to create a near-net shape profile for use in a polishing action or, in another embodiment, to create a conductive or non-conductive profile to be impressed into the deformable portion of the assembly to create a profile for machining.

Typically, either profile is created by using an article in the form of that which is subsequently to be machined or polished, an article prototype, a 3D print of the said article, or part thereof, or any other method of creating a surface with a shape profile which is required.

In one embodiment once the shape profile impression is formed in the said electrode assembly or assemblies, the shape is fixed and the electrode assembly or assemblies can be used for machining operations on a plurality of the articles with a surface to which the said shape profile impression relates and without the need to adjust the electrode assembly or assemblies.

In one embodiment, the said members are provided as a series of equally spaced conductive members. Typically, the members are provided in engagement with, and are relatively linearly moveable with respect to, an electrically conductive plate in which there are formed ports and said ports are typically concentric and receive therethrough a respective member. The ports are typically located in a continuous pattern across at least the deformable portion of the surface of the plate so as to retain the members in the spaced apart configuration.

In one embodiment the spacing of the members is selected to allow a sufficient degree of granularity to be achieved in the profile which is created and with respect to the type of article on which the polishing or machining work is to be performed. In one embodiment the selected spacing between said members is substantially uniform. In an alternative embodiment the spacing of members may vary between different locations and may be selected, for example, with regard to any, or any combination, of specific characteristics of the article; surface shape of the article; with regard to an edge of the surface and/or the quality of finish required.

In one embodiment the members are provides as a series of pins. In one embodiment each member or pin is provided to be substantially cylindrical. However it should be appreciated that the members may have any suitable geometric shaped cross section to suit the specific use, spacing and/or movement restrictions such as providing an anti-rotation feature to prevent rotational movement of the members around their longitudinal axis.

In one embodiment one or both ends of the member may be provided of different cross sectional shapes than the remainder of the member so as to provide an accurate depiction of the shape of the article surface and the particular shape of one or both ends may be selected with respect to the particular location of one or a subset of members with respect to the group of members.

In one embodiment the shape, dimensions and/or material used to form the members is selected with respect to the particular material with which the members are required to interact, such as the material of the article and/or the material of the dielectric fluid.

Typically retaining means are provided to prevent the pin from sliding out of the port in the plate. The retaining means may be an integral geometric feature of the pin such as a circumferential ring, or other deformation which prevents the pin from passing wholly though the port. Alternatively, a component may be fitted to the pin to prevent passage through the port, or the retention means may be provided in the form of a barrier which is located with respect to the rear of the plate by a distance which is less than the length of the pin.

Typically, in order to maintain the datum of the plate prior to movement of the members to create the profile, the members are biased, typically by one or more springs, to a position at which a free end of the same is at the maximum extension from the plate.

Typically, once the profile shape has been created in the front face of the assembly, locking means are engaged to retain the group of members in position so as to retain the profile shape as defined by the respective member positions.

Typically, the conductive plate is formed of metal and connected to a first pole of the power supply, while the article is connected to the opposing pole of the power supply. This allows, in conjunction with the conductive members, electrical potential to be transmitted to the surface of the electrode plate.

In one embodiment, when the apparatus is for use in a non-consumable machining process, the plates are made from a material which is resilient to the dielectric fluid being used in the process and in one embodiment stainless steel is selected. Furthermore, in this process a locking means can be used to retain the members in position once the profile shape has been created and during use of the apparatus.

In another embodiment, and particularly when the apparatus is for use in a consumable machining process, the electrode plates are typically made from copper or graphite, or another suitable material, with the selection being made with respect to any, or any combination of, the dielectric solution, the material of the article and/or the voltages being used. Furthermore, in this process, as the consumption of the electrode material during the process can be calculated, a feed means can be used to provide a calculated, controlled feed of the members with respect to the article so as to take into account material consumption whilst retaining the profile shape.

Thus, in accordance with the invention in one embodiment, the apparatus can be adapted to be used in different processes by the control and/or replacement of at least one of the plates and members associated therewith. Thus, it is possible to create a reusable, conforming electrode assembly that is of use across the wide domain of the non-conventional machining industry.

Typically the length of the members which are selected to be used for creating the shape profile impression of a particle article surface is such as to ensure that there is a range of possible axial movement of the members which is greater than the distance between the lowest and highest point of the surface of the article onto which the group of members is to be brought into contact. This therefore ensures that substantially all contour changes of the article surface can be captured with sufficient accuracy by the relative movement of the respective members so as to create an image which allows accurate polishing and/or machining operations to be performed.

In a further aspect of the invention there is provided a method for performing a polishing and/or machining effect on a surface of an article, said method comprising the steps of, locating said article in a fluid, providing at least one electrode assembly including a base or plate and at least one deformable portion, and causing relative movement between the article and the electrode assembly to bring the said deformable portion into contact with a surface of said article and wherein upon contact said deformable portion substantially takes the shape profile impression of said article surface and retaining substantial contact between the deformable portion and the article surface during the polishing and/or machining action.

In one embodiment the said deformable portion is formed by a plurality of elongate members, located in a spaced apart configuration on said base or plate and movable with respect to the base or plate such that the free ends of said members, in combination, take the shape profile impression of the said article surface when brought into contact therewith.

In one embodiment the respective distance of the ends of the members which contact with the surface of the article from the base or plate, varies with respect to the contours of the article surface.

In one embodiment the fluid is a dielectric fluid and said deformable portion is conductive.

In one embodiment a plurality of said electrode assemblies are provided and which are offset so as to be moved into contact with different parts of said surface of said article take the shape profile impression thereof.

Specific embodiments of the invention are now described with respect to the accompanying drawings; wherein

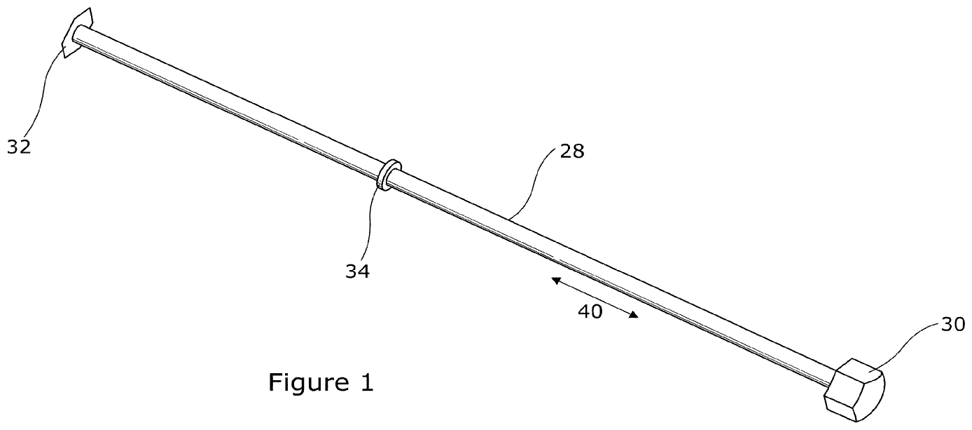

FIG. 1 illustrates an embodiment of a member in accordance with one embodiment of the invention;

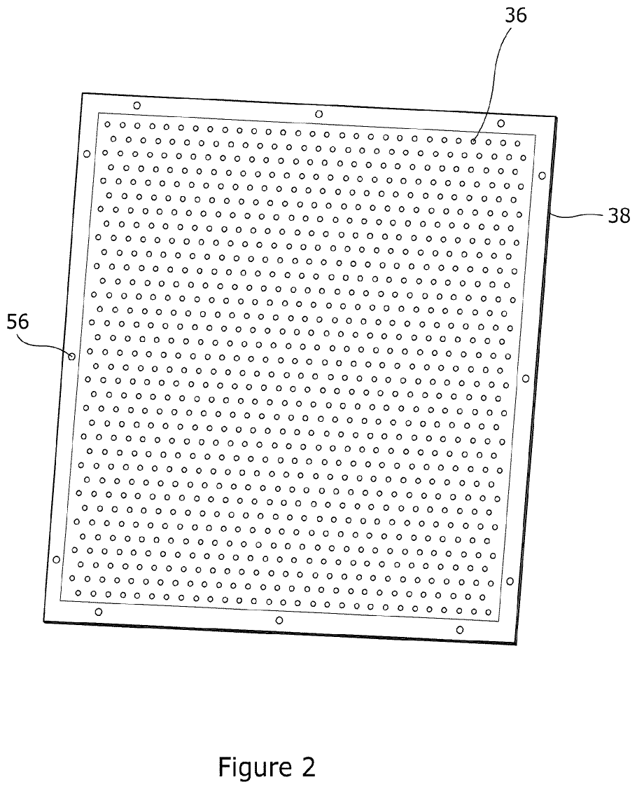

FIG. 2 illustrates an electrode plate in accordance with one embodiment of the invention;

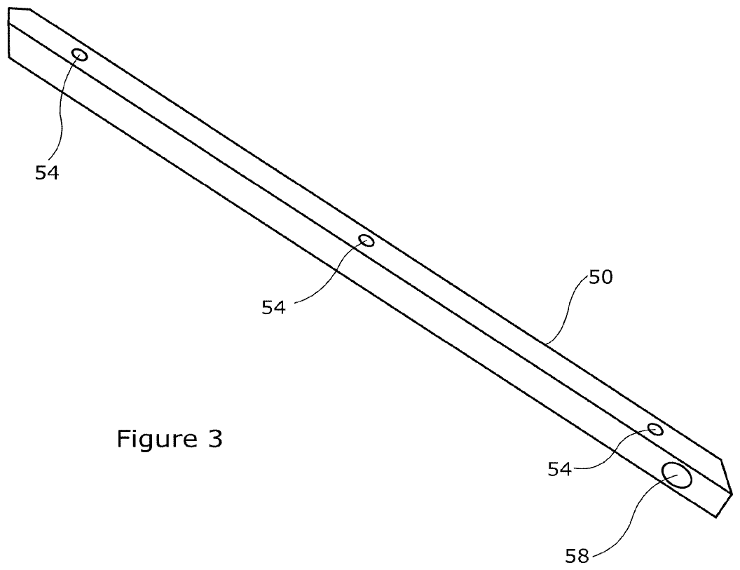

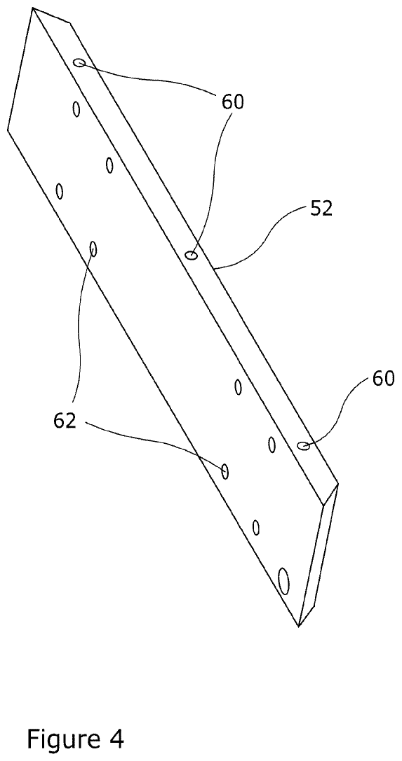

FIGS. 3 and 4 illustrate holder frame bars in accordance with one embodiment of the invention;

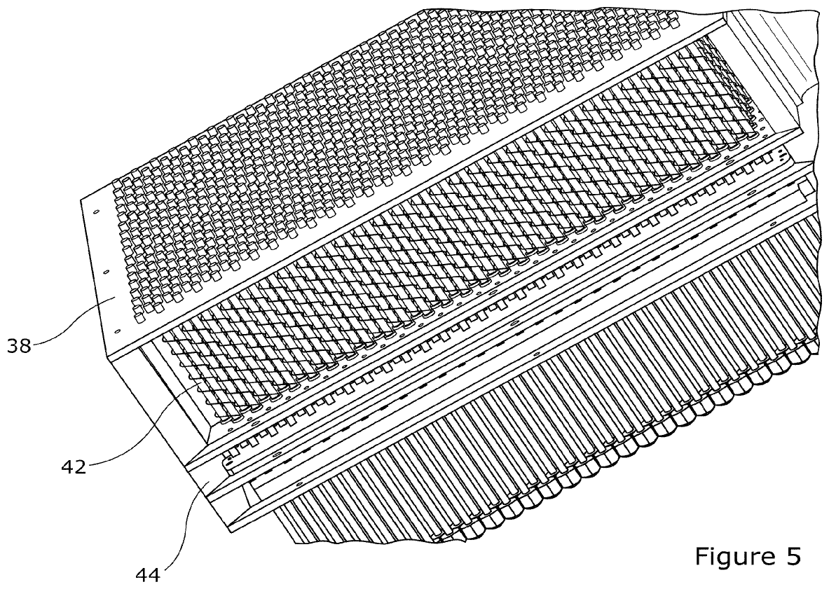

FIG. 5 illustrates an electrode assembly in accordance with one embodiment of the invention;

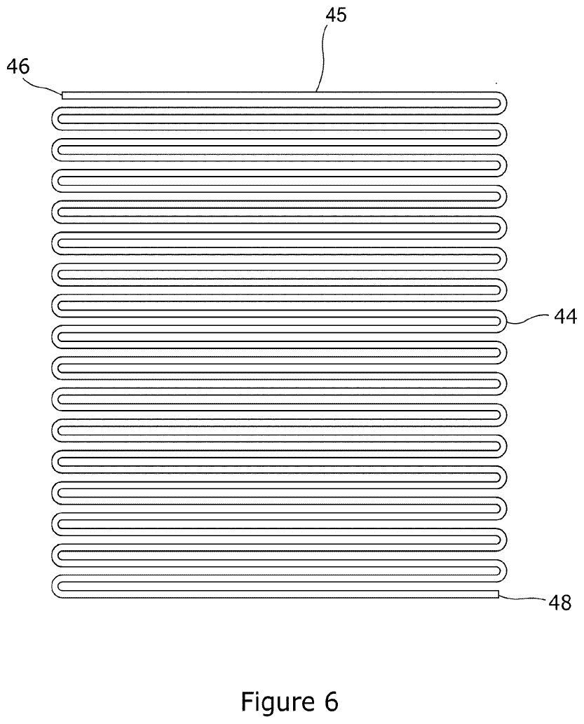

FIG. 6 illustrates an embodiment of a pneumatic locking means in accordance with one embodiment of the invention;

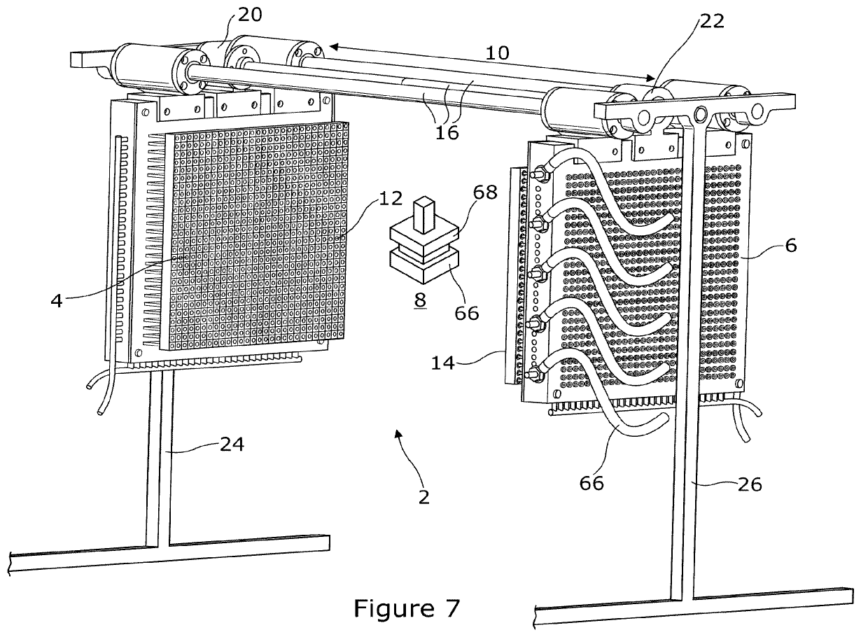

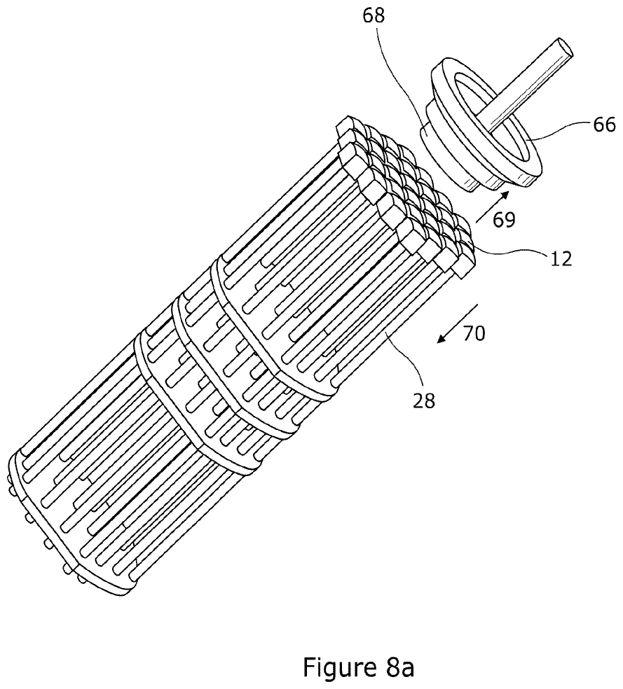

FIG. 7 illustrates apparatus formed in accordance with one embodiment of the invention; and

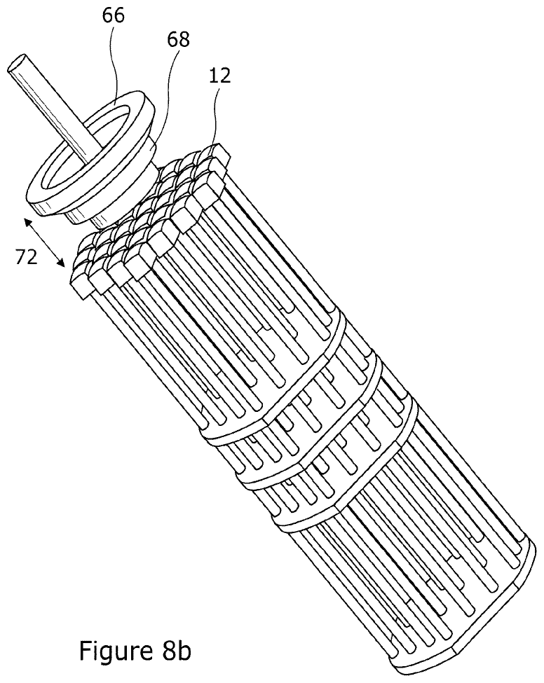

FIG. 8 a and b illustrate the manner in which members can be deformed with respect to an article in accordance with one embodiment of the invention.

Referring firstly to FIG. 7 there is illustrated an apparatus 2 in accordance with one embodiment of the invention.

The apparatus includes first and second electrode assemblies 4,6 which are spaced apart and define a space 8 between the same. The length 10 of the spaced defined between the front faces 12, 14 of the respective assemblies 4,6 is adjustable via movement of at least one of the assemblies along support rods 16 via bearing assemblies 20, 22. The support rods are mounted on stand legs 24, 26. The movement of the one or both electrode assemblies may be via motors provided as part of the bearing assemblies or may be by manual sliding movement exerted by a user of the apparatus. The movement is required to bring the front faces 12 and in particular the deformable portions thereof into contact with respective parts of the surface 68 of an article 66 which is positioned in said space 8 and between the first and second assemblies and then subsequently remove the assemblies from contact.

The construction of one of the said electrode assemblies, which is illustrated in FIG. 5, is now described with reference to FIGS. 1-7. The front face 12 of the assembly is formed by the combination of the head or free ends 30 of the said group of members and when brought into contact with the surface of the said article, each of the respective members is movable under the force and shape of the contact surface of the article so as to take up the shape profile impression of the surface of the article with which contact is made such that when the article is positioned with respect to the deformable portion contact or near contact is achieved between the deformable portion (the members) and the article surface which allows significantly improved granularity and quality of the surface finishing and polishing which can be achieved. As stated, the deformable front face is formed by the free ends 30 of the group of members 28 and one of the members is shown in detail in FIG. 1. In this example, the member is provided in the form of a cylindrical pin and includes, at one end, the head portion 30 and at the opposing end there is provided a cap portion 32. Intermediate the said ends there is provided a retaining feature 34.

The head portion 30 of the member, is provided to form, in conjunction with the other members 28, the front face of the assembly.

The members 28 are held in a selected and fixed spaced apart array by passing the same through respective ports 36 in plate or base 38 shown in FIG. 2, Each of the members are therefore permitted to be movable through the port in the direction of arrow 40 along the longitudinal axis of the member.

Each member is biased towards a fully extended position in which the free ends of the members are at their greatest possible distance from the plate so as to form the front face 12. The bias is achieved by the provision of a spring 42 which has sufficient force to slide the member 28 to the extended position but also is not so strong as to resist a movement of the member when the free end of the member is contacted onto the surface of the article and thereby allow the group of members in combination to take up the profile shape of the article surface.

Once the profile shape is created by the group of members, a locking means, in this embodiment in the form of a pneumatic locking means membrane 44, as shown in FIG. 6, is operated. The locking means in this embodiment are formed by the air flow membrane which has an internal passage formed by walls 45 and which has an air input end 46 and a sealed end 48 and, intermediate the ends, the membrane is configured as shown so as to pass and contact each of the member ends 32 and, when inflated, the walls of the passage retain the members in their respective positions at that time and so retain the profile shape on the front face of the electrode plate assembly during use of the apparatus. It should also be appreciated that other forms of locking means may be provided in the form, for example, of mechanical, electrical and/or magnetic means.

In order to maintain the respective components of the assembly together in the required form, side and end bars 50, 52 are provided as shown in FIGS. 3 and 4. The side bars 50 include assembly mounting holes 54 and an access passage 58 is provided to locate with the input end 46 of the locking means. The end bars 52 are provided with frame mounting holes 60 which match with those 56 on the plate 38 and electrical connector holes 62 are provided for reception of electrical power supply cables 64 shown in FIG. 7.

Typically, the assembly as described is repeated for the formation of the electrode plate assembly 6 and indeed third fourth or further electrode assemblies which are provided and each of which is typically angularly offset so as to respectively take up the shape profile impression of different parts of the article surface.

Thus, in order to illustrate the manner in which a shape profile impression is achieved, reference is now made to FIG. 8a and b. In FIG. 8a there is shown one group of the members 28 in a schematic manner for illustrative purposes and which form a deformable portion of a front face 12 located adjacent to an article 66 which is located in the space 8. The article has a surface 68 having a contoured profile which it is desired to recreate on the deformable portion of the front face 12. In order to do this, relative movement is performed between the electrode assembly and the article, in this embodiment by moving the electrode assembly such that the front face 12 formed by the free ends of the members 28 in the direction of arrow 69 so that the free ends of the members (which effectively form the deformable portion) contact with the surface 68 of the article and, with the article held in a fixed position, each of the members 28 is independently then moved in the direction 70 by a distance which is determined by the particular part and contour shape of the surface 68 of the article 66 at which each respective member contacts. This can mean, for example, that the distance of the free end of a member from the base or plate 38, differs to the distance of the free end of an adjacent member from the plate and so on for all the members which are in contact with the surface of the article and so provides, in combination, a deformable portion which takes, via the respective positions of the free ends of the said members, the shape profile impression of the article surface. When the profile shape has been created on the front face 12 with the ends 30 of each of the members 32 contacting the respective part of the article surface 68, the locking means are operated to retain the members 28 in their respective positions.

With the locking means having been activated, the polishing and machining can then be performed on the surface of the article and the members 28 and article 66 are then moved apart as indicated by arrows 72. If the shape profile impression has been taken from a sample of the article, the electrode assemblies are moved apart and the sample removed and replaced by successive articles and the electrode assemblies moved into contact with the article so as to perform the machining and/or polishing work and the steps repeated in sequence for successive articles with the shape profile impression of the deformable portions still locked in position for the use with the successive articles of the same shape profile impression.

The locked profiled and contoured shape of the front face 12 can then be used for the polishing and/or machining operations of the type herein described through the application of electrical power and the article and at least the free ends of the members immersed in a dielectric fluid. It should also be appreciated that in one embodiment the electrode assemblies can be integrated as part of the walls of the container in which the article is held and in which the dielectric fluid is located so that the electrode assemblies are moved into position to take the shape profile impression and subsequently retained in position to perform the machining operation of the surfaces of the article with which the said members have made contact.

1. Apparatus for use in creating a machining or polishing effect on a surface of an article located with respect to said apparatus, said apparatus comprising:
at least one electrode assembly including a base or plate and at least one deformable portion which is relatively moveable in response to contact being made with a surface of said article so as to substantially take a shape profile impression of said surface of said article.

2. Apparatus according to claim 1 wherein the electrode assembly is provided for use with a non-conventional machining and/or polishing apparatus utilising electro chemical machining (ECM) or electrical discharge machining (EDM).

3. Apparatus according to claim 1 wherein the at least one deformable portion is formed by a group of members, each having a free end such that as a group, the free ends of said members take the profile shape of said surface with which the same contact.

4. Apparatus according to claim 3, wherein the electrode assembly includes means to retain the group of members in their respective positions and hence maintain the profile shape created by the free ends of the respective members.

5. Apparatus according to claim 3 wherein each of said members in the group is independently movable within a predefined range of movement with respect to said base or plate.

6. Apparatus according to claim 5 wherein said members are restricted to a linear movement along their respective longitudinal axis.

7. Apparatus according to claim 1, wherein the at least one deformable portions are conductive.

8. Apparatus according to claim 1, wherein the electrode assembly is provided in position with respect to a conductive membrane which is a conductive surface with a degree of flexibility which is sufficient to allow the members to be movable with respect thereto along their respective longitudinal axis without adhering to the membrane and allow the members to be movable under influence of biasing means to contact with and take the shape profile impression of the surface of said article.

9. Apparatus according to claim 1, wherein a first electrode assembly is provided on a first side of the article and a second electrode assembly is provided on a second side of the article and the relative position of at least one of said electrode assemblies and article is adjustable so as to allow relative movement and contact of the same and cause the shape profile impression of the contacted surface of the article to be taken by the at least one deformable portion of the electrode assembly.

10. Apparatus according to claim 9, wherein all of the electrode assemblies are movable towards contact with the surface of said article so that the deformable portions of the contacted surface of the article is taken up by the respective deformable portions of said electrode assemblies.

11. Apparatus according to claim 1, wherein the one or more electrode assemblies are provided as, or as part of, respective walls of a tank or container in which said article and a dielectric fluid is held.

12. Apparatus according to claim 1, wherein a plurality of electrode assemblies are provided each angularly offset with respect to the position of said article and provided to take the shape profile impression of different parts of the surface of the said article.

13. Apparatus according to claim 1, wherein the members are provided as a series of equally spaced conductive members.

14. Apparatus according to claim 13 wherein the members are provided in engagement with and are relatively linearly movable with respect to said base or plate on which there are formed ports which receive therethrough a respective member.

15. Apparatus according to claim 14 wherein the ports are located in a substantially continuous pattern across at least part of the surface of the plate so as to retain the members in a group of said members in a spaced apart configuration and form the deformable portion.

16. Apparatus according to claim 1, wherein the spacing of the members is selected with respect to a required granularity and quality of the surface finish for the shape profile impression of the article when represented by the deformable portion.

17. Apparatus according to claim 16 wherein the spacing between said members is substantially uniform.

18. Apparatus according to claim 16 wherein the spacing between said members varies between different locations and with regard to any or any combination of specific characteristics of the article, surface shape of the article, with regard to an edge of the surface and/or the quality of finish required.

19. Apparatus according to claim 1 wherein a cross-sectional shape of each of pin in at least one deformable portion of the electrode assembly is substantially the same.

20. Apparatus according to claim 19 wherein the cross-sectional shape of the member at or adjacent to at least one end of the same is different to the cross-sectional shape of the member intermediate opposing ends of the member.

21. Apparatus according to claim 1, wherein the members include, or have fitted thereto, and/or the electrode assembly includes, retaining means to retain the members in location with said base or plate.

22. Apparatus according to claim 1, wherein the members are biased, typically by one or more resilient means to a position at which the free end of the members is biased towards its maximum possible distance from the base or plate.

23. Apparatus according to claim 1, wherein the apparatus includes locking means to retain the group of members of a deformable portion in the position to which the same are adjusted by contact with the surface of the article so as to retain the shape profile impression.

24. Apparatus according to claim 1, wherein the base or plate is formed of a conductive material and connected to a first pole of a power supply with the article being connected to the opposing pole of the power supply so as to provide, in conjunction with the conductive members, electrical potential to be transmitted to the surface of the said base or plate.

25. Apparatus according to claim 1, wherein a movement feed means is used to provide a controlled movement of the members in the deformable portion with respect to the article so as to take into account material consumption during the performance of the surface finish operation during use of the apparatus.

26. Apparatus according to claim 1, wherein the length of the members of the deformable portion is sufficient such that a range of possible axial movement of the members is greater than a distance between the lowest and highest points of the surface of the article onto which the group of members is to be brought into contact.

27. Apparatus according to claim 1, wherein the deformable portion includes a flexible outer skin which defines a cavity in which a fluid material is held and said article surface is positioned against the flexible outer skin to allow the same to take the shape profile impression of the surface of the article with which it contacts.

28. A method for performing a polishing and/or machining effect on a surface of an article, said method comprising the steps of:
locating said article in a fluid,
providing at least one electrode assembly including a base or plate and at least one deformable portion, and
causing relative movement between the article and the electrode assembly to bring the deformable portion into contact with a surface of said article and wherein upon contact said deformable portion substantially takes a shape profile impression of said article surface and retaining substantial contact between the deformable portion and the article surface during the polishing and/or machining action.

29. A method according to claim 28 wherein the deformable portion is formed by a plurality of elongate members, located in a spaced apart configuration on said base or plate and movable with respect to the base or plate such that the free ends of said members, in combination, take the shape profile impression of the article surface when brought into contact therewith.

30. A method according to claim 29 wherein a respective distance of the ends of the members which contact the surface of the article from the base or plate, varies with respect to contours of the article surface.

31. A method according to claim 28 wherein the fluid is a dielectric fluid and said deformable portion is conductive.

32. A method according to claim 28 wherein a plurality of said electrode assemblies are provided and which are offset so as to be moved into contact with different parts of said surface of said article take the shape profile impression thereof.
